(19) United States
(12) Patent Application Publication
(10) Pub. No.: US 2013/0346837 A1
(43) Pub. Date: Dec. 26, 2013

(54) COMMUNICATION DEVICE

(71) Applicant: FUJITSU LIMITED, Kawasaki-shi (JP)

(72) Inventor: Kenji MITSUHASHI, Hachioji (JP)

(73) Assignee: FUJITSU LIMITED, Kawasaki-shi (JP)

(21) Appl. No.: 13/847,638

(22) Filed: Mar. 20, 2013

(30) Foreign Application Priority Data
Jun. 22, 2012 (JP) 2012-140915

(51) Int. Cl. G06F 11/10

(52) U.S. Cl. CPC G06F 11/1004
USPC 714/807

(57) ABSTRACT

A communication device includes a division circuit configured to divide a data block received from a network into a plurality of cells, a plurality of processing circuits, each configured to execute predetermined processing with respect to the plurality of cells received from the division circuit, an assembling circuit configured to assemble the data block from the plurality of cells received from the plurality of processing circuits, and a first control circuit configured to determine whether or not mismatch is present in a plurality of calculation results stored in the cell, wherein at least two of the division circuit, the plurality of processing circuits, and the assembling circuit store the calculation result of error check calculation with respect to at least one of the plurality of cells, in the cell.

### CROSS-REFERENCE TO RELATED APPLICATION

This application is based upon and claims the benefit of priority of the prior Japanese Patent Application No. 2012-140915, filed on Jun. 22, 2012, the entire contents of which are incorporated herein by reference.

### FIELD

The embodiment discussed herein is related to a communication device.

### BACKGROUND

High-speed and high-capacity packet forwarding is demanded in a communication device such as a core router and an edge router which constitutes an internet protocol (IP) network. Therefore, a communication device which executes packet forwarding by hardware processing is provided. A communication device which executes packet forwarding by hardware processing (hardware logic) divides a packet which is received from a network and has a variable size into a plurality of cells having a fixed size and performs uniform switching and buffering in a cell state therein. Accordingly, high-speed packet forwarding is realized. Subsequently, a packet is assembled from a plurality of cells and the packet is transmitted to the network.

Japanese Laid-open Patent Publication No. 5-22329 is an example of related art.

### SUMMARY

According to an aspect of the invention, a communication device includes: a division circuit configured to divide a data block received from a network into a plurality of cells; a plurality of processing circuits, each configured to execute predetermined processing with respect to the plurality of cells received from the division circuit; an assembling circuit configured to assemble the data block from the plurality of cells received from the plurality of processing circuits; and a first control circuit configured to determine whether or not mismatch is present in a plurality of calculation results stored in the cell, wherein at least two of the division circuit, the plurality of processing circuits, and the assembling circuit store the calculation result of error check calculation with respect to at least one of the plurality of cells, in the cell.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a network system to which a communication device according to an embodiment is applicable;

FIG. 2 schematically illustrates the circuit configuration of the communication device according to the embodiment;

FIG. 3 is a diagram (hardware configuration diagram) illustrating details of each circuit block which are depicted in FIG. 2;

FIG. 4A schematically illustrates conversion of a packet into cells performed by a L2/L3 processing engine;

FIG. 4B illustrates a format example of a cell;

FIG. 5 schematically illustrates a function which is realized by hardware of the communication device depicted in FIG. 3;

FIG. 6 illustrates an operation example of the communication device, specifically, an example of information storage with respect to a cell;

FIG. 7 is a flowchart illustrating a processing example of a packet division circuit (L2/L3 processing engine);

FIG. 8 is a flowchart illustrating a processing example of a QoS processing circuit (traffic manager);

FIG. 9 is a flowchart illustrating a processing example of a switch (switch device);

FIG. 10 is a flowchart illustrating a processing example of a packet assembling circuit (L2/L3 processing engine);

FIG. 11 illustrates an operation example of a reproduction test using a test packet T1;

FIG. 12 illustrates an operation example of a reproduction test using test packets T2 and T3;

FIG. 13 illustrates shared memory diagnosis processing using shared memory address information;

FIG. 14 is a flowchart illustrating a processing example of a device control circuit (reproduction test module) according to the above-described reproduction test and a failure confirmation test;

FIG. 15 illustrates a display example of failure notification information; and

FIG. 16 illustrates a display example of failure notification information.

### DESCRIPTION OF EMBODIMENTS

The communication device such as a core router and an edge router which constitutes an IP network includes a plurality of forwarding units that perform processing related to forwarding of a packet which is received from a network and a switching unit which performs switching with respect to a plurality of cells which are generated through division of a packet, for example. The switching unit commonly includes a multiple-stage switch which includes a plurality of switches. A packet which is received by one of the forwarding units is divided into a plurality of cells to be inputted into the switching unit. The switching unit refers to information imparted to the cells and forwards the cells to the forwarding unit which is on a transmission side. The forwarding unit on the transmission side assembles an original packet from a plurality of cells. After error check of whether or not the assembled packet includes an error is performed, the packet is transmitted to the network. Thus, a cell travels in a predetermined cell transmission path which runs from a forwarding unit on a reception side to a forwarding unit on a transmission side via a multiple-stage switch.

The above-described error check method to determine whether or not a restored packet includes an error enables confirmation of presence of an error of a packet. However, it has been difficult to specify a failure occurrence part, at which an error occurs, on a cell transmission path. Accordingly, there has been a possibility that a service of a communication device is interrupted and an operation for specifying a failure occurrence part is demanded so as to specify a failure occurrence part. At this time, there has been a possibility that check of the whole of the cell transmission path is demanded.

Further, when an error occurs, determination of whether or not the error is a transient error or a permanent error (an error which may intermittently occur) is demanded, so as to resolve a failure causing the error. For such determination, a reproduction test in which a resource and a data pattern which are same as those in an occurrence of an error are prepared is commonly performed. However, it has been difficult to perform a reproduction test during a service of the communication device.

It is desirable to provide a technique which facilitates specification of a failure occurrence part in a cell transmission path.

An embodiment of the present disclosure is described below with reference to the accompanying drawings. The configuration of the embodiment is an exemplification and the present disclosure is not limited to the configuration of the embodiment.

### <Network Configuration Example>

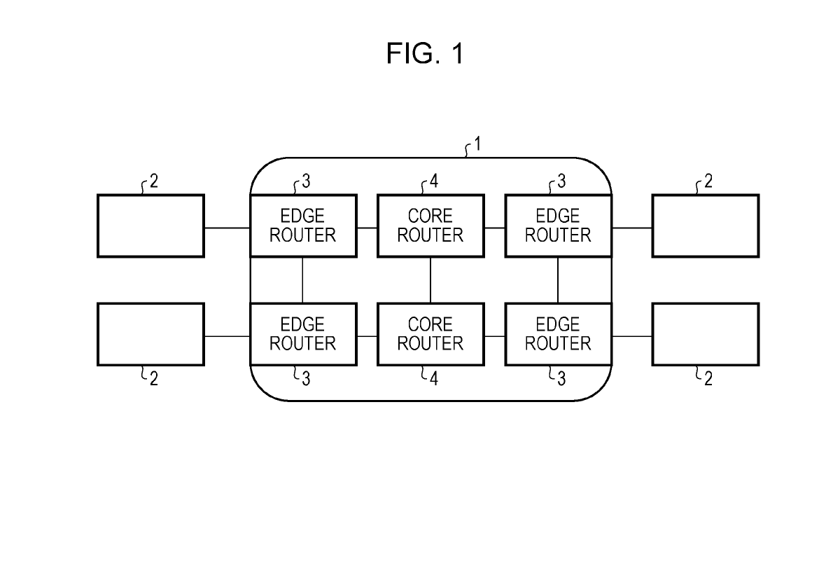

FIG. 1 illustrates an example of a network system to which a communication device according to the embodiment is applicable. In FIG. 1, a network system includes a core network 1 and a plurality of access networks 2 which are connected with the core network 1. The core network 1 functions as a backbone network which couples the access networks 2 to each other.

The core network 1 includes edge routers (also referred to as edge nodes) 3 which are disposed on a boundary between the access networks 2 and the core network 1 (an entrance and an exit of the core network) and core routers (also referred to as core nodes) 4 which couples the edge routers 3 to each other. The number and a connection state (topology) of the edge routers 3 and the core routers 4 depicted in FIG. 1 are examples and are arbitrarily set in accordance with a purpose of the core network 1.

The access network 2 is an optical network, for example, and the edge router 3 converts an optical signal received from the access network 2 into an electric signal so as to obtain an IP packet. An IP packet travels from the edge router 3 on the entrance through one or more core routers 4 to reach the edge router 3 on the exit, in accordance with a destination address of the IP packet, for example. The IP packet is converted into an optical signal again at the edge router 3 on the exit and transmitted to the access network 2 which is connected with the edge router 3 on the exit.

The above-described edge routers 3 and core routers 4 are examples of a communication device. However, a use application of the communication device is not limited to the edge routers 3 and the core routers 4. Further, the edge routers 3 and the core routers 4 may be mutually connected via an optical line. Furthermore, it is not a prerequisite that the access networks 2 are optical networks, but the access networks 2 may be access networks which are electrically connected with the core network 1. The access network 2 is an example of a “network”.

Further, the above-described IP packet is an example of a “packet” and the packet is an example of a “data block”. A data block may include a frame such as a MAC frame.

### <Configuration Example of Communication Device>

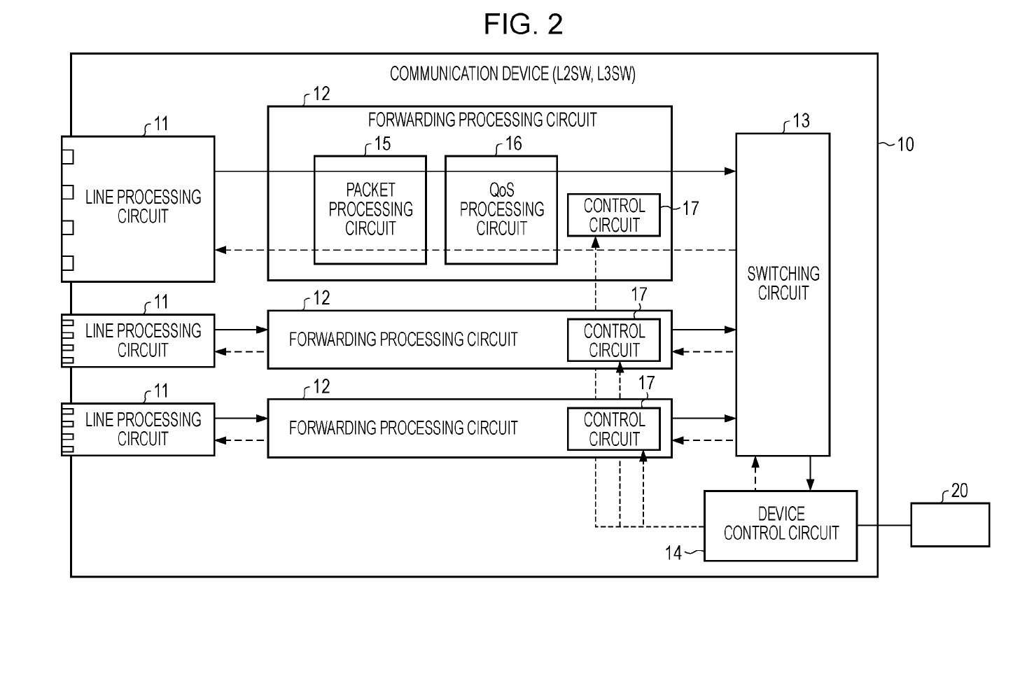

FIG. 2 schematically illustrates the circuit configuration of a communication device according to the embodiment. FIG. 2 illustrates the configuration of a layer 3 switch (L3SW) which is applicable as the above-described edge router 3 and core router 4, as an exemplification of the communication device. Here, the L3SW depicted in FIG. 2 is capable of functioning as a layer 2 switch (L2SW). Thus, the communication device includes the L2SW and the L3SW. Regarding the communication device 10 depicted in FIG. 2, the configuration related to the function as the L3SW is mainly described below.

Referring to FIG. 2, the communication device 10 includes a plurality of line processing circuits 11, a plurality of forwarding processing circuits 12 which are respectively connected with the line processing circuits 11, a switching circuit 13 to which the forwarding processing circuits 12 are connected, and a device control circuit 14 which is connected with the switching circuit 13. Further, each of the forwarding processing circuits 12 includes a packet processing circuit 15, a quality of service (QoS) processing circuit 16, and a control circuit 17.

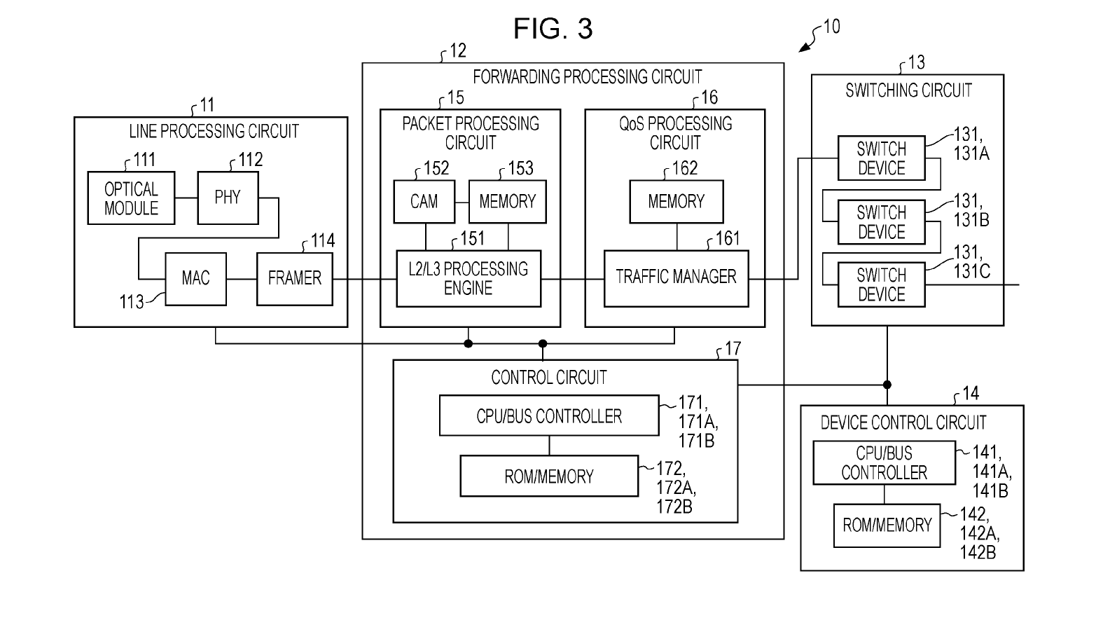

FIG. 3 illustrates details of each circuit block which is depicted in FIG. 2 (a hardware configuration drawing of the communication device 10). However, the line processing circuits 11 depicted in FIG. 2 have the same configurations as each other and the forwarding processing circuits 12 depicted in FIG. 2 have the same configurations as each other. Therefore, FIG. 3 illustrates the hardware configuration with a single line processing circuit 11 and a single forwarding processing circuit 12.

### <<Line Processing Circuit>>

The line processing circuit 11 is a so-called communication interface (communication interface circuit) and stores a plurality of lines which are connected with a network such as the access network 2 depicted in FIG. 1.

Referring to FIG. 3, the line processing circuit 11 includes a plurality of transmission ports and a plurality of reception ports (not depicted) that store a plurality of lines, and further includes an optical module 111, a PHY 112, a media access controller (MAC) 113, and a framer 114.

The optical module 111 performs processing of converting an optical signal which is received from an optical line (optical fiber) which is connected to the reception port into an electric signal (optical-electric conversion). Further, the optical module 111 performs processing of converting an electric signal which is received from the PHY 112 into an optical signal (electric-optical conversion) so as to output the optical signal from the transmission port.

The PHY 112 performs processing of layer 1, that is, a physical layer. For example, the PHY 112 shapes a waveform of an electric signal which is inputted from the optical module 111. The MAC 113 performs processing related to layer 2 (data link layer) including a media access control (MAC) layer. A MAC frame is generated from an electric signal by the MAC 113 and the framer 114 so as to be transmitted to the forwarding processing circuit 12.

The optical module 111, the PHY 112, the MAC 113 and the framer 114 perform operations opposite to the above-described processing with respect to a MAC frame which is received from the packet processing circuit 15 and transmit an optical signal which is finally generated from the output port to the optical line.

The optical module 111, the PHY 112, the MAC 113, and the framer 114 are realized by application of a general-purpose device chip (general-purpose circuit chip). Here, a dedicated hardware chip is applicable as well. The framer 114 is realized by a combination of a field-programmable gate array (FPGA) and an application specific integrated circuit (ASIC), for example.

### <<Forwarding Processing Circuit>>

As described above, the forwarding processing circuit 12 includes the packet processing circuit 15, the QoS processing circuit 16, and the control circuit 17.

### [Packet Processing Circuit]

The packet processing circuit 15 includes a L2/L3 processing engine 151, a content addressable memory (CAM) (associative memory) 152, and a memory 153. The memory 153 is used as a storage region of a MAC frame (IP packet).

The L2/L3 processing engine 151 executes layer 2 processing associated with a MAC frame which is inputted from the line processing circuit 11 (for example, reception processing of a MAC frame) and layer 3 processing with respect to an IP packet which is included in a received MAC frame (for example, routing).

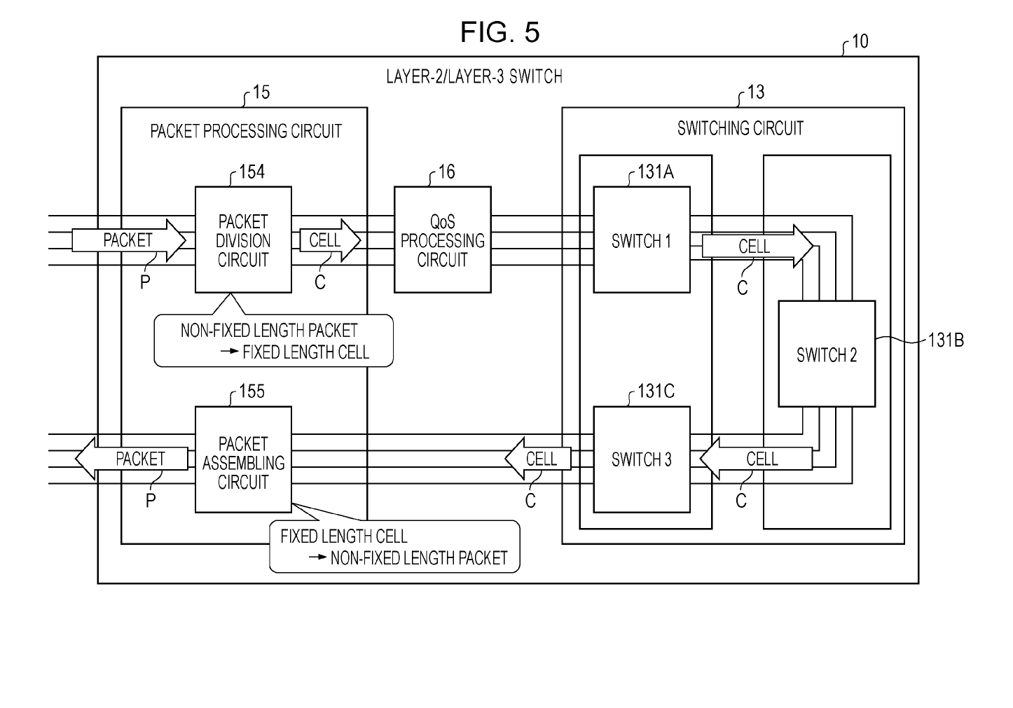

The L2/L3 processing engine 151 functions as a packet division circuit (packet division device) 154 (FIG. 5) which divides an IP packet into a plurality of cells, so as to execute high-speed packet forwarding in the communication device 10.

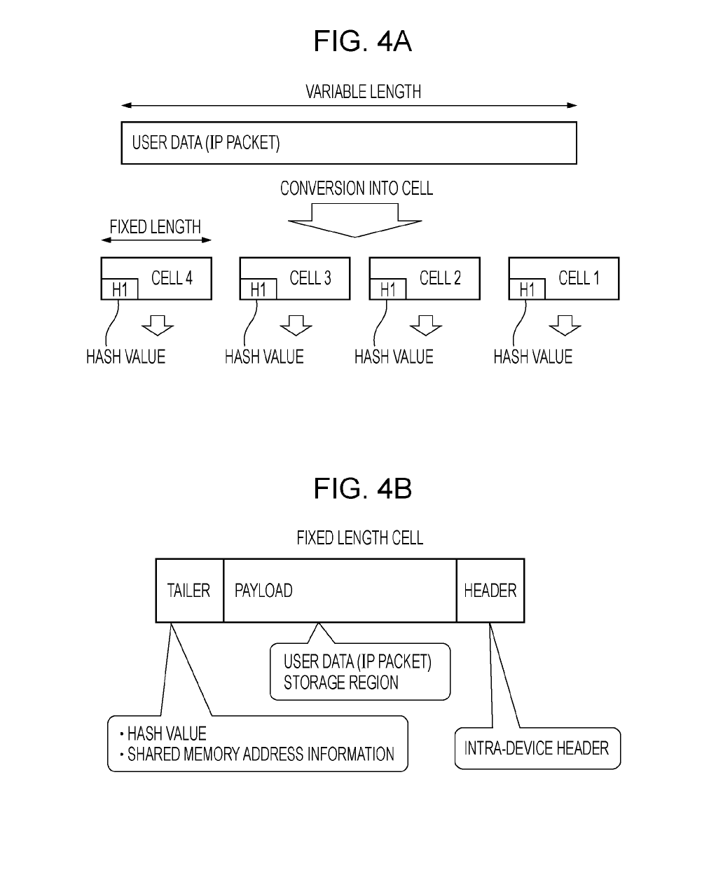

FIG. 4A schematically illustrates conversion of an IP packet into cells performed by the L2/L3 processing engine 151 and FIG. 4B illustrates a format example of a cell. As depicted in FIG. 4A, the L2/L3 processing engine 151 divides variable sized user data (IP packet) into a plurality of cells respectively having fixed sizes. FIG. 4A illustrates an example in which one user data is divided into four cells. However, the division number of an IP packet (the number of cells which are generated through division) varies depending on a size of user data.

A cell is composed of a header, a payload, and a tailer each of which has a fixed size, as depicted in FIG. 4B. A payload is a storage region of divided user data. The L2/L3 processing engine 151 divides an IP packet which is stored in the memory 153 in a payload size which is a fixed size while functioning as the packet division circuit 154. Accordingly, a plurality of segments of user data are generated. Each of the segments is a payload of a cell. Here, when a user data size is indivisible in a payload size, a payload corresponding to a remainder of the user data segments is composed of the remainder of the user data segments and padding. In this case, a padding size is stored in a header.

A header and a tailer are imparted to a payload. In a header, intra-device header information (information which is used only inside the communication device 10) which includes a cell identifier (for example, sequence number), destination information of a cell (destination identifier), the above-described padding size, and assembling information of a cell (for example, the division number of a packet and an offset position (relative position of a segment with respect to user data before division)) is stored.

A destination identifier is an internal identifier which is used for forwarding of a cell in the communication device 10. The CAM 152 depicted in FIG. 3 is used as a MAC address table and a routing table. For example, when a destination IP address of an IP packet is inputted, the CAM 152 outputs a destination identifier of a cell corresponding to this destination IP address. The L2/L3 processing engine 151 (packet division circuit 154) stores an outputted destination identifier in a header.

The tailer is a region to store data in the tail of the cell. In the tailer, a hash value which is a result obtained by calculating a bit column, which constitutes a payload of a cell or a header and a payload of a cell, by a predetermined hash function. Calculation of a hash function (hash operation) is an example of “error check calculation” and a hash value is an example of a “calculation result of the error check calculation”. However, error check calculation and a calculation result of the error check calculation which are applicable in the embodiment are not limited to a hash operation and a hash value respectively. For example, an error correction code operation and an error correction code which is obtained by the error correction code operation are applicable, instead of a hash operation and a hash value, as “error check calculation” and a “calculation result of the error check calculation” respectively.

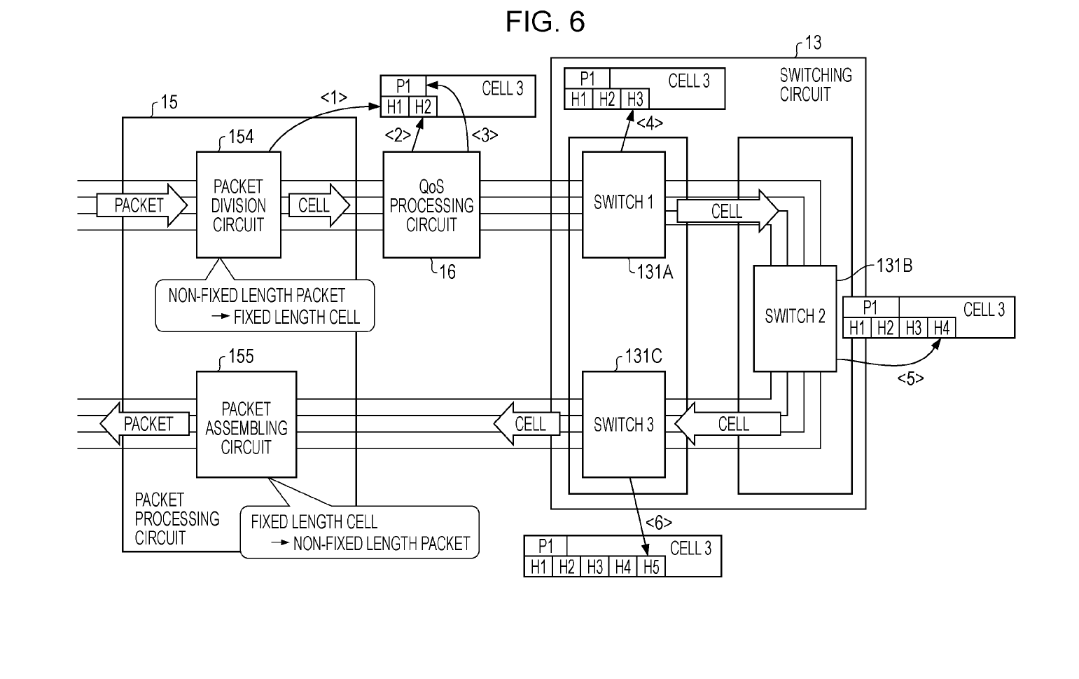

Further, a plurality of hash values which are obtained by performing the hash operation a plurality of times with respect to a corresponding cell are written in a tailer. In a later-described operation example, a plurality of circuits (the packet division circuit 154, the QoS processing circuit 16, switches 1 to 3, and a packet assembling circuit 155) disposed on a cell transmission path perform the hash operation using same hash functions for a cell and store hash values in a tailer of the cell (refer to FIG. 6). A plurality of hash values are written in a tailer in a manner to agree with an arranging order of a plurality of circuits which write the hash values respectively in the tailer, for example. Accordingly, which circuit has written each hash value is figured out, by referring to a plurality of hash values. Further, it is possible to specify presence/absence of an error of a cell and a failure occurrence position causing the error from a state of a plurality of hash values. That is, when a plurality of hash values includes mismatch, it is possible to detect that a cell has an error. Further, it is possible to detect that a failure occurs between circuits which have written respective hash values, from variation of hash values. Furthermore, a hash value may be written in a tailer with identification information of a circuit which has written the hash value.

Further, shared memory address information is stored in a tailer. In this embodiment, the QoS processing circuit 16 includes a memory 162 which is used as a shared memory and is an example of “memory”. Information indicating an address of a shared memory which is used for cell storage by the QoS processing circuit 16 is stored in a tailer as shared memory address information. “memory address information” may be an address of the shared memory or may be an address pointer. Further, a hash value and shared memory address information which are stored in a tailer of a cell are collectively referred to as “tailer information”.

Further, the L2/L3 processing engine 151 functions as the packet assembling circuit (packet assembling device) 155 which assembles original user data (IP packet) from a plurality of cells which come from the switching circuit 13.

Namely, the L2/L3 processing engine 151 stores respective cells which reach from the switching circuit 13 in the memory 153 and removes a header and a tailer. Then, the L2/L3 processing engine 151 connects payloads on the basis of header information of the cells so as to assemble (restore) original user data (IP packet). At this time, a hash value and shared memory address information which are stored in the tailer (referred to as “tailer information”) are transmitted to the device control circuit 14.

As the CAM 152 and the memory 153 of the packet processing circuit 15, general-purpose devices (that is, a CAM chip, a memory chip) are applicable, for example. However, a dedicated hardware chip is also applicable. The L2/L3 processing engine 151 is realized by a combination of an ASIC and a network processor, for example.

### [QoS Processing Circuit]

The QoS processing circuit 16 includes a traffic manager 161 and the memory 162. The QoS processing circuit 16 performs QoS processing corresponding to a QoS class which is preliminarily assigned with respect to a plurality of cell flows which pass through the QoS processing circuit 16. The QoS processing is priority control, or priority control and band control, for example.

The memory 162 temporarily stores a cell which is inputted from the packet processing circuit 15. For example, the memory 162 has a plurality of buffer regions which are prepared in accordance with a QoS class. The respective buffers are shared among cell flows. Accordingly, the memory 162 is used as a shared memory.

The traffic manager 161 performs readout control of cells which are stored in the respective buffers on the basis of a QoS class corresponding to a flow of each cell. That is, the traffic manager 161 functions as a scheduler of cell readout timing. The traffic manager 161 reads out a cell from a corresponding buffer region at timing decided by the scheduler and transmits the cell to the switching circuit 13.

The memory 162 described above is realized by using a general-purpose memory chip, for example. On the other hand, the traffic manager may be realized by a combination of an ASIC and a general-purpose device chip.

### [Control Circuit]

The control circuit 17 is connected with the line processing circuit 11, the packet processing circuit 15, and the QoS processing circuit 16 via a bus. The control circuit 17 includes a CPU/bus controller 171 which includes a central processing unit (CPU) 171A and a bus controller 171B and a ROM/memory 172 which includes a read only memory (ROM) 172A and a memory (for example, random access memory (RAM)) 172B.

The CPU 171A loads a program which is stored in the ROM 172A on the memory 172B to execute the program, for example. Accordingly, the CPU 171A controls operations of the line processing circuit 11, the packet processing circuit 15, and the QoS processing circuit 16 via the bus controller 171B.

As the CPU 171A, the bus controller 171B, the ROM 172A, and the memory 172B, general-purpose device chips are applicable. However, a dedicated hardware chip is also applicable. Here, the control circuit 17 is a local control circuit which is provided to each of the forwarding processing circuits 12, and control of the whole of the communication device 10 is executed by the device control circuit 14. The control circuit 17 is an example of a “first control circuit”.

Here, the packet processing circuit 15, the QoS processing circuit 16, and the control circuit 17 which are described above may have the circuit configurations different from the above-described circuit configuration examples as long as the packet processing circuit 15, the QoS processing circuit 16, and the control circuit 17 are capable of realizing respective functions.

### <<Switching Circuit>>

The switching circuit 13 includes a plurality of switch devices 131 which are connected in series. FIG. 3 illustrates three switch devices 131 (131A, 131B, 131C). However, the number of switch devices 131 may be arbitrarily set.

Each of the switch devices 131 includes a plurality of input ports and a plurality of output ports. Each of the switch devices 131 refers to a destination identifier which is stored in a header of a cell and outputs the cell from a corresponding output port. For example, the switch device 131 includes an association table (not depicted) between a destination identifier and an output port and outputs a cell from an output port corresponding to a destination identifier.

Alternatively, such configuration may be employed that an association table holds an association relationship among a destination identifier, a destination identifier on an output side, and an output port and the switch device 131 rewrites a destination identifier which is stored in a cell with a destination identifier on the output side before forwarding the corresponding cell to an output port corresponding to a destination identifier of the inputted cell.

The respective switch devices 131 are connected with the forwarding processing circuits 12 depicted in FIG. 2, though not illustrated in FIG. 3. Each of the switch devices 131 transmits a cell to the forwarding processing circuit 12 corresponding to an address of a cell (IP packet).

That is, when a destination identifier of a cell indicates forwarding to a specific forwarding processing circuit 12, each of the switch devices 131 transmits the cell to the specific forwarding processing circuit 12. On the other hand, when a destination identifier of a cell indicates forwarding to a next switch device 131, each of the switch devices 131 forwards the cell to the next switch device 131. Thus, the plurality of switch devices 131 function as a multiple-stage switch which allocates a cell which is inputted into the switching circuit 13 to a target forwarding processing circuit 12.

Further, each of the switch devices 131 executes error check calculation (hash operation) with respect to a received cell and stores a calculation result (hash value) in a tailer of the cell. Hash operation is executed in every switch device 131.

### <Device Control Circuit>

The device control circuit 14 includes a CPU/bus controller 141 which includes a CPU 141A and a bus controller 141B and a ROM/memory 142 which includes a ROM 142A and a memory (for example, a RAM) 142B.

The device control circuit 14 is connected with each of the forwarding processing circuits 12 and the switching circuit 13 via the bus. The CPU 141A loads a program which is stored in the ROM 142A on the memory 142B so as to execute the program, for example. Accordingly, the device control circuit 14 monitors operations of the forwarding processing circuits 12 and the switching circuit 13 and performs control based on a monitoring result via the bus controller 141B. For example, the device control circuit 14 executes a reproduction test, shared memory diagnosis, and failure processing which will be described later. The device control circuit 14 is an example of a “second control circuit”. The CPU 141A, the bus controller 141B, the ROM 142A, and the memory 142B may be respectively realized by using general-purpose device chips.

FIG. 5 schematically illustrates a function which is realized by hardware of the communication device 10 depicted in FIG. 3. As depicted in FIG. 5, the packet processing circuit 15 functions as a circuit which is provided with the packet division circuit 154 and the packet assembling circuit 155. On the other hand, the switching circuit 13 functions as a device which is provided with a multiple-stage switch (switch 1, switch 2, and switch 3) respectively corresponding to a plurality of switch devices 131A, 131B, and 131C depicted in FIG. 3. The packet division circuit 154 and the packet assembling circuit 155 are respectively examples of a “division circuit” and an “assembling circuit”.

An IP packet (FIG. 5, P) which is received at the packet division circuit 154 is divided into a plurality of cells (FIG. 5, C) and outputted. Each of the cells is inputted into the switching circuit 13 after passing through the QoS processing circuit 16. In the example depicted in FIG. 5, each cell which is inputted into the switching circuit 13 passes through switch 1 (the switch device 131A), switch 2 (the switch device 131B), and switch 3 (the switch device 131C) to reach the packet assembling circuit 155 of the packet processing circuit 15. The packet assembling circuit 155 assembles and outputs a packet.

Thus, a plurality of cells which are generated from an IP packet travel through a predetermined cell transmission path (the packet division circuit 154→the QoS processing circuit 16→switch 1→switch 2=switch 3=the packet assembling circuit 155) which is formed in the communication device 10. Further, the QoS processing circuit 16 and switches 1 to 3 are examples of “a plurality of processing circuits”.

Here, FIG. 5 illustrates an example in which the packet division circuit 154 and the packet assembling circuit 155 are provided to one forwarding processing circuit 12 (packet processing circuit 15) for the sake of simplicity of the description. There is commonly such case that a forwarding processing circuit 12 which is provided with the packet division circuit 154 which generates a plurality of cells differs from a forwarding processing circuit 12 which is provided with the packet assembling circuit 155 which assembles an IP packet from a plurality of cells.

Accordingly, processing related to a later-described reproduction test is executed by the device control circuit 14 which executes control of the whole device, on the assumption of a case where a cell transmission path straddles two forwarding processing circuits 12.

### <Operation Example>

### <<Tailer Information Storage>>

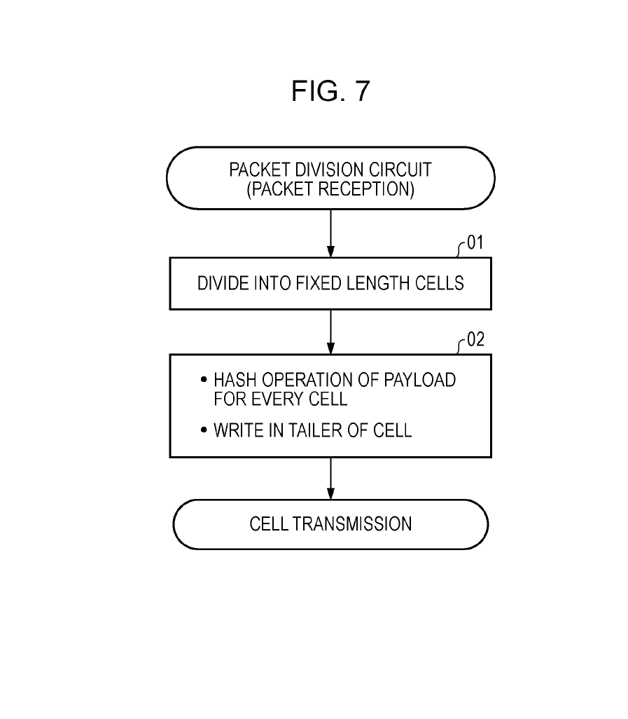

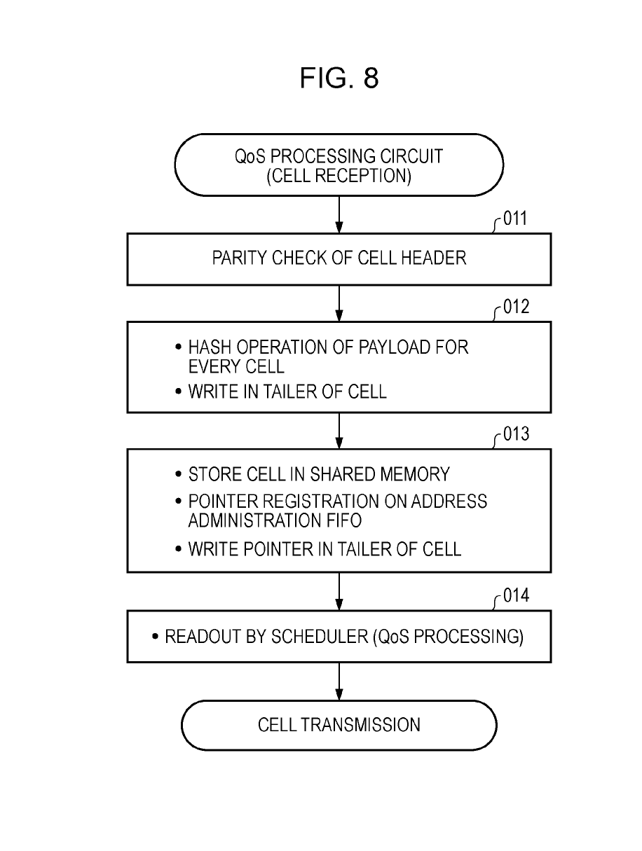

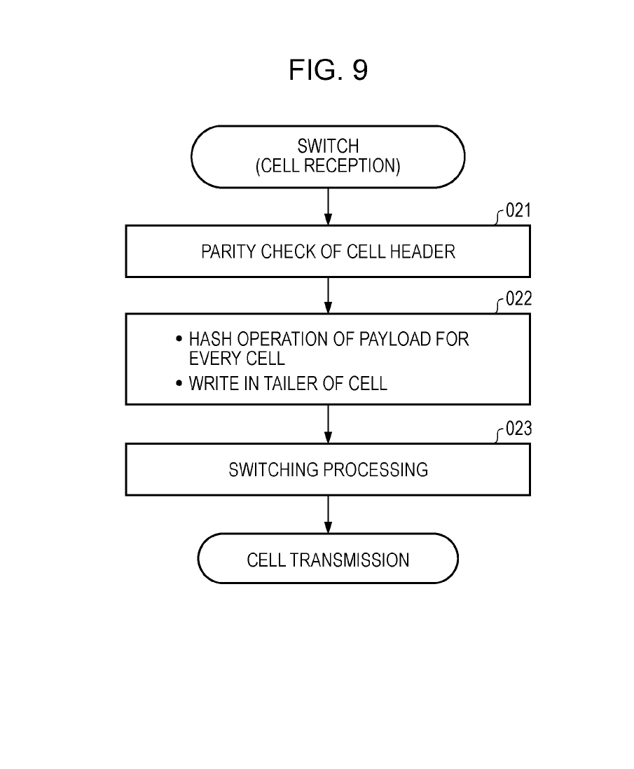

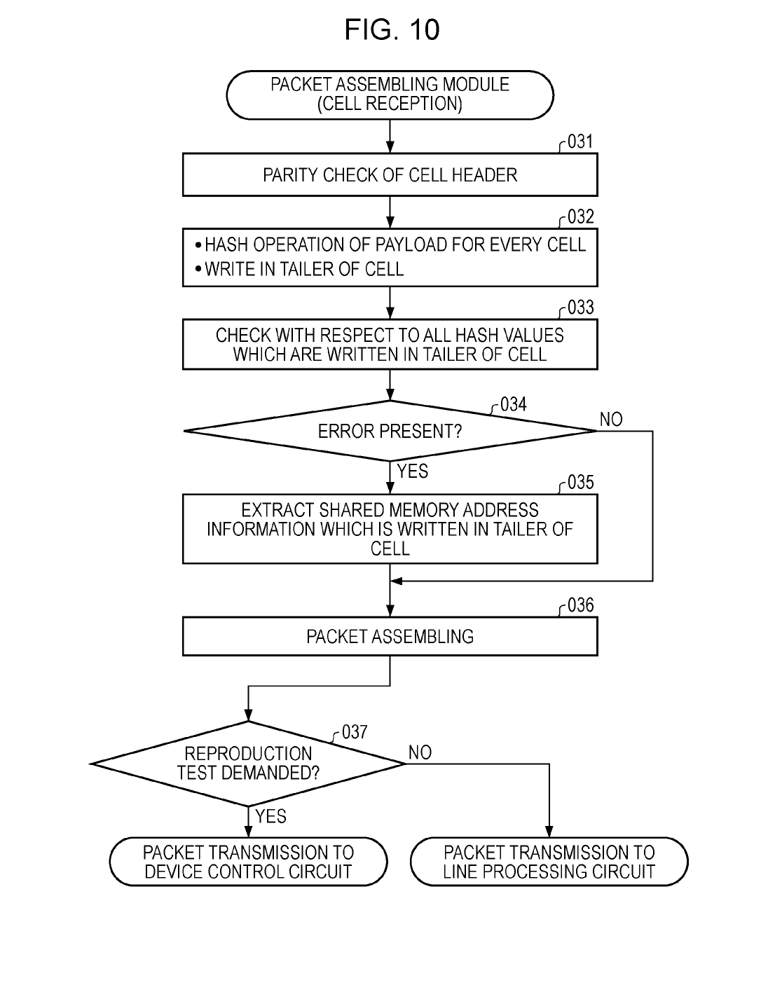

FIG. 6 illustrates an operation example of the communication device 10, specifically, an example of tailer information storage with respect to a cell. FIG. 7 is a flowchart illustrating a processing example of the packet division circuit 154 (the L2/L3 processing engine 151). FIG. 8 is a flowchart illustrating a processing example of the QoS processing circuit 16 (the traffic manager 161). FIG. 9 is a flowchart illustrating a processing example of switches 1 to 3 (the switch devices 131). FIG. 10 is a flowchart illustrating a processing example of the packet assembling circuit 155 (the L2/L3 processing engine 151).

In FIG. 6, when an IP packet is inputted into the packet division circuit 154, the packet division circuit 154 starts processing illustrated in FIG. 7. The packet division circuit 154 divides the received IP packet into a plurality of cells (operation 01). Subsequently, the packet division circuit 154 performs hash operation of a payload for each of the cells and writes a hash value in a tailer of each of the cells (operation 02). Then, the packet division circuit 154 transmits each of the cells.

In this operation example, such case is assumed that an IP packet is divided into cell 1, cell 2, cell 3, and cell 4 by the packet division circuit 154 to be outputted as depicted in FIG. 4A. However, FIG. 6 illustrates only cell 3. In tailers of respective cells 1 to 4, a hash value “H1” which is calculated in the packet division circuit 154 is stored (FIG. 4A and <1> in FIG. 6).

Subsequently, cells 1 to 4 are inputted into the QoS processing circuit 16. The QoS processing circuit 16 starts processing illustrated in FIG. 8 with respect to received cells 1 to 4. Namely, the QoS processing circuit 16 first executes parity check of headers of cells 1 to 4 so as to confirm that header information has no error (operation 011).

Subsequently, the QoS processing circuit 16 performs hash operation of a payload for each of the cells and writes a hash value in tailers of cells 1 to 4 (operation 012). Then, the QoS processing circuit 16 stores cells 1 to 4 in a shared memory (a buffer of the memory 162) and registers address pointers (a writing start pointer and a writing end pointer) on an address administration first-in first-out (FIFO) which is formed in the memory 162. After that, the QoS processing circuit 16 writes the address pointers in the tailers of cells 1 to 4 (operation 013). An address pointer is an example of “memory address information”. Then, the QoS processing circuit 16 reads the cells out by a scheduler (QoS processing) (operation 014) and cells 1 to 4 which are read out from the buffer are transmitted to the switching circuit 13. Here, the processing of the operation 012 and the processing of the operation 013 may be performed in an inverse order.

Through the processing illustrated in FIG. 8, cells 1 to 4 are temporarily stored in the memory 162 (shared memory) included in the QoS processing circuit 16. After that, cells 1 to 4 are read out at timing corresponding to a QoS class and transmitted to the switching circuit 13.

Further, in the QoS processing circuit 16, the traffic manager 161 stores a hash value “H2” in the tailers of cells 1 to 4 (<2> in FIG. 6). Further, the traffic manager 161 stores an address of the memory 162 in which the cells are written, that is, shared memory address information “P1” in the tailers of cells 1 to 4 (<3> in FIG. 6).

Cells 1 to 4 are inputted into switch 1 of the switching circuit 13. Then, switch 1 starts processing illustrated in FIG. 9. That is, switch 1 performs parity check of a cell header (operation 021). Subsequently, switch 1 performs hash operation of a payload for each of the cells and writes a hash value in the tailers of the cells (operation 022). Then, switch 1 performs switching processing (operation 023). By the switching processing, switch 1 forwards cells 1 to 4 to switch 2 in accordance with destination identifiers which are respectively stored in the headers of cells 1 to 4. At this time, a recalculated hash value “H3” is stored in the tailers of cells 1 to 4 (<4> in FIG. 6).

Switch 2 performs the processing illustrated in FIG. 9 and forwards cells 1 to 4 to switch 3 in accordance with the destination identifiers. At this time, switch 2 executes hash operation with respect to cells 1 to 4 and stores a hash value “H4” in the tailers of cells 1 to 4, as is the case with switch 1 (<5> in FIG. 6).

Switch 3 also performs the processing (FIG. 9) same as that of switches 1 and 2 and a hash value “H5”, which is a hash operation result in switch 3, is stored in the tailers of cells 1 to 4 (<6> in FIG. 6). Respective cells 1 to 4 are transmitted to the packet assembling circuit 155 of the packet processing circuit 15 in accordance with destination identifiers.

The packet assembling circuit 155 executes processing illustrated in FIG. 10 with respect to the cells 1 to 4 which are received. That is, the packet assembling circuit 155 performs parity check of cell headers (operation 031). Subsequently, the packet assembling circuit 155 performs hash operation of a payload for each of the cells and writes a hash value “H6” (not depicted) in the tailers of cells 1 to 4 (operation 032).

Then, the packet assembling circuit 155 checks whether or not all hash values written in the tailer of the cell agree with each other in cells 1 to 4 (operation 033). In this case, when all hash values agree with each other, the packet assembling circuit 155 determines that a bit error is not present in a payload (NO in operation 034) and progresses the processing to operation 036. On the other hand, when the hash values includes mismatch, the packet assembling circuit 155 determines that a bit error is present in the payload (YES in operation 034) and progresses the processing to operation 035.

In operation 035, the packet assembling circuit 155 extracts shared memory address information (address pointer information) which is stored in the tailers of the cells. Subsequently, the packet assembling circuit 155 executes assembling processing of an original IP packet on the basis of header information of cells 1 to 4 (operation 036). Here, the processing of above-described operations 031 to 035 may be individually executed with respect to cells 1 to 4.

Then, the packet assembling circuit 155 determines whether or not a reproduction test is demanded (operation 037). When the above-described mismatch of the hash values is found, it is determined that a reproduction test is demanded. When all of the hash values agree with each other, it is determined that a reproduction test is not demanded.

When a reproduction test is demanded (YES in operation 037), the packet assembling circuit 155 forwards an assembled IP packet to the control circuit 17 and the control circuit 17 forwards the IP packet to the device control circuit 14. That is, the IP packet is transmitted to the device control circuit 14. On the other hand, when a reproduction test is not demanded (NO in operation 037), the packet assembling circuit 155 transmits the IP packet (MAC frame) to the corresponding line processing circuit 11.

In the processing example illustrated in FIG. 10, the packet assembling circuit 155 performs match/mismatch determination of hash values. That is, such configuration that the packet assembling circuit 155 (assembling circuit) “includes a control circuit which determines whether or not mismatch is present in a plurality of calculation results (hash values) stored in a cell” is employed. On the other hand, the packet assembling circuit 155 may transmit information stored in a tailer of a cell to the control circuit 17 and the CPU 171A of the control circuit 17 may execute the above-described processing of operations 033, 034, 035, and 037. That is, such configuration that a control circuit independent from the packet assembling circuit 155 (assembling circuit) “determines whether or not mismatch is present in a plurality of calculation results (hash values) stored in a cell” may be also employed.

### [[Function Effect by Storage of Hash Value (Error Check Calculation Result)]]

According to the embodiment, hash values of payloads are stored in the tailer of each of cells 1 to 4 in the packet division circuit 154, the packet assembling circuit 155, and a plurality of processing circuits (the QoS processing circuit 16 and switches 1 to 3) which perform predetermined processing with respect to the cells, as described above. Then, the packet assembling circuit 155 determines, for each of the cells, whether or not a plurality of hash values stored in the tailer agree with each other.

At this time, when all hash values in the cell agree with each other, it may be determined that a payload is normal and there is no failure in a transmission path of the cell. On the other hand, when mismatch is present in a plurality of hash values in the cell, it may be interpreted that the payload of the cell includes a bit error and it may be determined that a failure has occurred on the transmission path of the cell. Further, it may be estimated that a failure has occurred between circuits which have written mismatched hash values.

For example, such configuration that the hash values H1 to H6 are stored in a tailer of a cell in an order of writing, as described above, is assumed. Here, when the hash value H1 does not agree with the hash values H2 to H6, it may be estimated or specified that a bit error has occurred between the packet division circuit 154 by which the hash value H1 has been stored and the QoS processing circuit 16 by which the hash value H2 has been stored. Further, when the hash values H1 to H3 do not agree with the hash values H4 and H5, it may be estimated or specified that a bit error has occurred between switch 1 and switch 2.

Furthermore, when the hash values H1 and H2, the hash values H3 and H4, and the hash values H5 and H6 do not agree with each other, for example, it may be estimated or specified that a bit error has occurred between the QoS processing circuit 16 and switch 1 and a bit error has further occurred between switch 2 and switch 3 as well. Thus, it is possible to estimate or specify an occurrence part of one or more failures on the transmission path of a cell.

When a plurality of hash values in a cell include mismatch, such configuration that the hash values are outputted (are displayed on a display device included in a terminal 20 depicted in FIG. 2, or are printed on a sheet by a printing device which is not depicted, for example) is applicable, for example. When this configuration is employed, it is possible to specify an occurrence part of a failure (error) on the transmission path of a cell by referring to a plurality of outputted hash values which include mismatch.

Here, in the above-described embodiment, such configuration that hash values are stored in all cells which are obtained through division is illustrated. However, hash values may be stored in at least one of a plurality of cells which are obtained through division. However, frequency of error detection is increased by increasing the number of cells in which hash values are stored. That is, error detection accuracy is enhanced.

Further, in the above-described embodiment, such configuration is illustrated that the packet division circuit 154, the QoS processing circuit 16, switches 1 to 3, and the packet assembling circuit 155 perform hash operation and store hash values in a cell. However, it is not prerequisite for all circuits which perform processing with respect to a cell on a cell transmission path to store hash values in the cell. That is, at least two circuits may store hash values among a plurality of circuits which perform processing with respect to the cell on the cell transmission path (including a start point and an end point). Circuits which perform hash value storage may be variously selected. For example, the configuration in which the packet assembling circuit 155 does not perform the hash value storage, the configuration in which only switches 1 to 3 perform the hash value storage, and the configuration that only the QoS processing circuit 16 and switches 1 to 3 perform the hash value storage may be selected.

### <<Reproduction Test>>

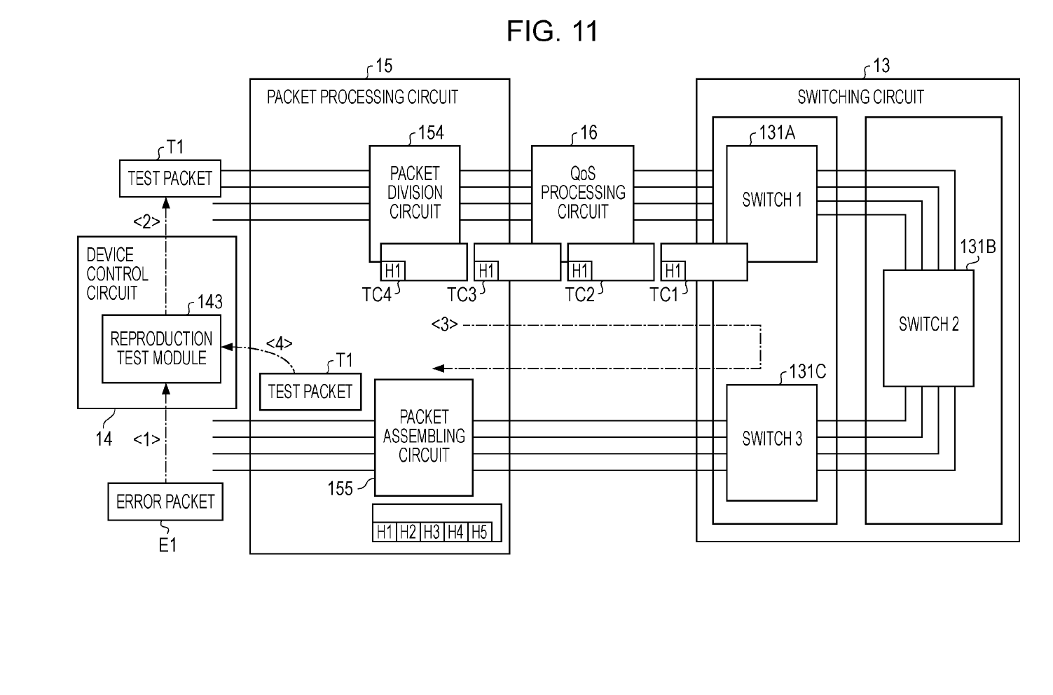

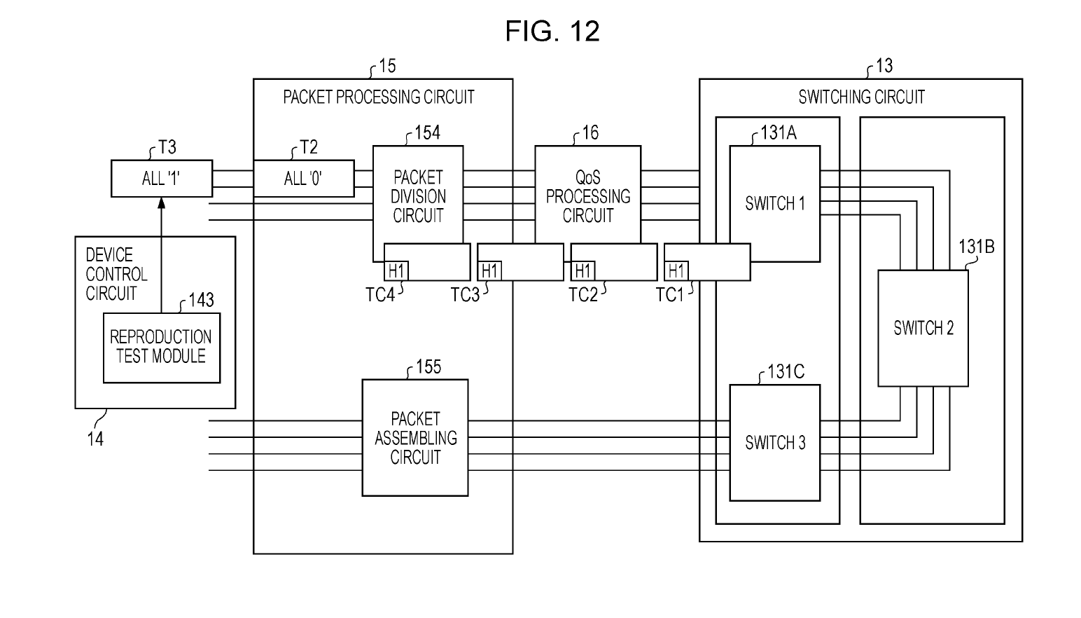

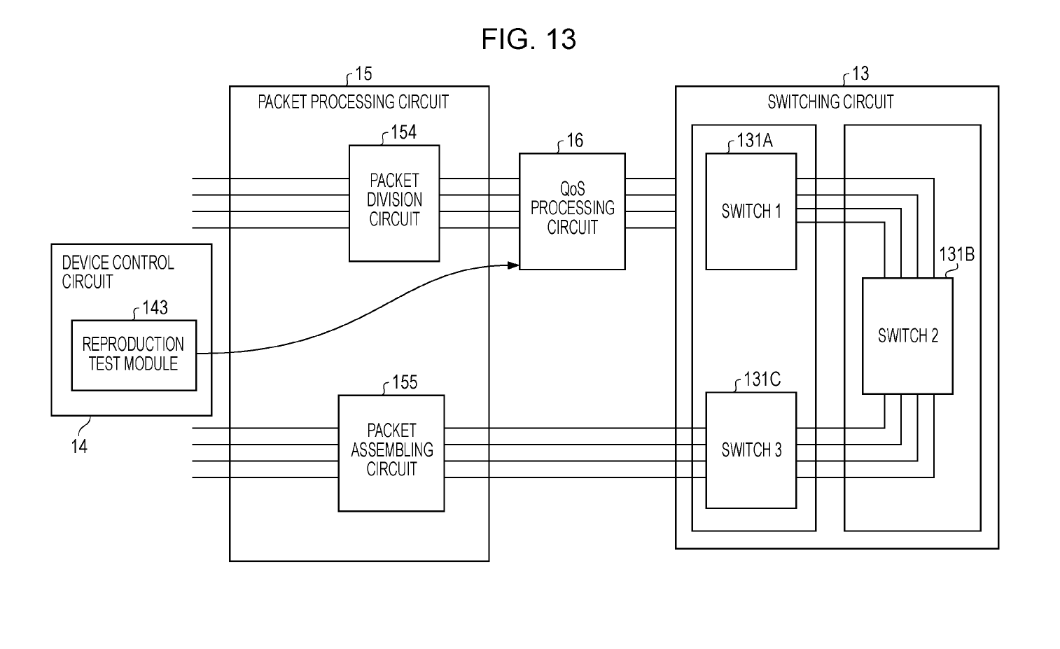

An operation example of a reproduction test which is executed after the end of the processing of the packet assembling circuit 155 illustrated in FIG. 10 is described. FIG. 11 illustrates an operation example of a reproduction test using a test packet T1. FIG. 12 illustrates an operation example of a reproduction test using test packets T2 and T3. FIG. 13 illustrates shared memory diagnosis processing using shared memory address information.

### [Reproduction Test Using Test Packet T1]

When the packet assembling circuit 155 determines that a reproduction test is demanded (YES in operation 037), an IP packet (referred to below as an “error packet E1” (refer to FIG. 11)) which is assembled in the packet assembling circuit 155 (L2/L3 processing engine 151) and is a reproduction test object is transmitted to the device control circuit 14 (<1> in FIG. 11), as illustrated in FIG. 10. At this time, tailer information of respective cells (a plurality of hash values and shared memory address information) is also transmitted to the device control circuit 14.

The error packet E1 and the tailer information are stored in the memory 142B of the device control circuit 14. When the error packet E1 is received, the CPU 141A functions as the reproduction test module 143 (refer to FIG. 11) in accordance with execution of a program and performs the following operation.

Namely, the reproduction test module 143 generates a test packet for a reproduction test. In this embodiment, the reproduction test module 143 generates a test packet T1 obtained by setting a test flag (test packet identifier) on a copy of the error packet E1. The test packet T1 is an example of a “first test data block”.

The test packet T1 is forwarded to the control circuit 17 of the forwarding processing circuit 12 including the packet division circuit 154 (the packet processing circuit 15) which has divided an original of the error packet E1.

The control circuit 17 transmits the test packet T1 to the packet division circuit 154 (<2> in FIG. 11). Accordingly, the packet division circuit 154, the QoS processing circuit 16, switches 1 to 3, and the packet assembling circuit 155 perform processing same as that for the original IP packet, with respect to the test packet T1 (<3> in FIG. 11).

That is, the test packet T1 is divided into a plurality of test cells at the packet division circuit 154 (FIG. 11 illustrates an example in which the test packet T1 is divided into four test cells TC1 to TC4). The test cells pass through the QoS processing circuit 16 and switches 1 to 3 to reach the packet assembling circuit 155. That is, the test cells flow a cell transmission path same as that of an original cell. At this time, the hash values H1 to H6 and shared memory address information are stored in a tailer of each of the cells, as is the case with the original cell.

Then, the test packet T1 which is assembled in the packet assembling circuit 155 and tailer information related to the test packet T1 are transmitted to the reproduction test module 143 (<4> in FIG. 11). The packet assembling circuit 155 recognizes the IP packet as a test packet from a test flag provided to the assembled IP packet. The packet assembling circuit 155 does not transmit an IP packet which is recognized as a test packet to the line processing circuit 11.

When all of a plurality of hash values in a cell related to the test packet T1 are same as each other, on the basis of the tailer information, the reproduction test module 143 may determine that a failure causing an occurrence of the error packet E1 is a transient failure. On the other hand, when a state of mismatch of a plurality of hash values may be equated with a state of mismatch of a plurality of hash values related to an original IP packet, it may be determined that a failure is reproduced, that is, a permanent failure (an error which intermittently occurs) has occurred.

For example, when the hash values H1 to H5 do not agree with the hash value H6 among a plurality of hash values (assumed as the hash values H1 to H6) related to an original IP packet and the hash values H1 to H5 do not agree with the hash value H6 among a plurality of hash values related to the test packet T1, it may be determined that a failure occurs on the same parts.

Here, the error packet E1, that is, the test packet T1 includes a bit error and a test flag with respect to an original IP packet. Therefore, even if a cell transmission path is normal, a hash value different from a hash value which is calculated with respect to the original IP packet is calculated.

### [Function Effect of Reproduction Test Related to Test Packet T1]

According to the above-described reproduction test using the test packet T1, a reproduction test using the test packet T1 which is a copy of the error packet E1 is performed. Accordingly, it is possible to perform a reproduction test in almost same conditions as those in a failure occurrence related to an original IP packet. Accordingly, it is possible to execute confirmation of reproducibility presence/absence with high accuracy. Further, a reproduction test is executed in almost same conditions as those in a failure occurrence related to an original, being able to narrow down failure suspected parts.

Further, it is possible to execute a reproduction test by putting the test packet T1 in a cell transmission path (inputting into the packet division circuit 154). Accordingly, it is possible to perform a reproduction test during an operation (during service) of the communication device 10. In other words, it is possible to avoid operation stop, for a reproduction test, of the communication device 10.

For example, such case is assumed that the hash values H1 to H5 do not agree with the hash value H6 among a plurality of hash values related to the test packet T1, while the hash values H1 to H4 do not agree with the hash values H5 and H6 among a plurality of hash values related to an original. In this case, it may be determined that a failure on a part corresponding to the hash value H5 (between switch 2 and switch 3) is a transient failure. On the other hand, it may be determined that there is high possibility (suspect degree) that a part corresponding to the hash value H6 (between switch 3 and the packet assembling circuit 155) is a permanent failure part. The number of times of the above-described reproduction test using the test packet T1 is not limited to one, but the reproduction test may be performed sufficient times. Accordingly, it is possible to enhance accuracy of discrimination between a transient failure and a permanent failure and accuracy in narrowing down of suspected parts of a permanent failure.

### [Reproduction Test Using Test Packets T2 and T3]

There is a case where a failure causing a bit error of a payload of a cell is caused by a memory stack failure (a phenomenon in which a certain address of a memory is fixed to “1” or “0” and it becomes hard to rewrite the address) of a memory provided to the packet processing circuit 15, the QoS processing circuit 16, and the switch devices 131.

Such case is assumed that a reproduction test using the test packet T1 is performed in a state that a bit error of an original IP packet occurs due to bit inversion caused by a memory stack failure. In this case, the bit error (inverted bit) included in the test packet T1 is generated due to bit inversion caused by the memory stack failure. Therefore, a bit value of an address fixed due to the memory stack failure is same as a bit value of the inverted bit. Accordingly, when a test cell is written in an address same as that of an original cell, bit inversion similar to that of the original cell does not occur. Accordingly, the memory stack failure is not reflected to a hash value of a payload of the test packet T1. Thus, there has been a possibility that it is erroneously determined that the failure does not have reproducibility.

To solve such problem, the following processing is performed in a reproduction test executed in the reproduction test module 143. Namely, as depicted in FIG. 12, the reproduction test module 143 generates a test packet (all zero packet) T2 of which all bit values in at least an error determination region are “0” (except for a test flag “ON”=1) and a test packet (all one packet) T3 of which all bit values in at least the error determination region are “1” (test flag “ON”=1) and performs a reproduction test same as that of the test packet T1 with respect to the test packets T2 and T3.

The test packets T2 and T3 have the same size as the original IP packet. The error determination region is a region excluding a storage region of test flags of the test packets T2 and T3. However, when it is possible to determine whether or not a received packet is a test packet without setting test flags for the test packets T2 and T3, the storage region of the test flags may be set to “0” or “1”. For example, when an occupancy of “0” or “1” in a received packet is equal to or larger than a predetermined threshold value, processing for determining that the received packet is the test packet T2 or T3 is performed, being able to avoid setting of test flags with respect to the test packets T2 and T3. The test packet T2 is an example of a “second test data block”, and the test packet T3 is an example of a “third test data block”.

The test packets T2 and T3 are transmitted to the packet division circuit 154 so as to be divided into a plurality of test cells. Respective test cells travel through a cell transmission path same as that of an original cell so as to be received at the packet assembling circuit 155. The packet assembling circuit 155 assembles the test packets T2 and T3 by using the received test cells. The packet assembling circuit 155 transmits the test packets T2 and T3 which are assembled and tailer information of the test cells which are used for assembling of the test packets T2 and T3 to the reproduction test module 143.

The reproduction test module 143 determines whether or not a plurality of hash values, which are included in the tailer information of the test packets T2 and T3, in a cell are same as each other. A case where the hash values related to the test packet T2 or T3 do not agree with each other indicates that at least one bit of a payload is inverted. Accordingly, when a plurality of hash values do not agree with each other, it may be determined that a memory stack failure has occurred at a part on which variation of a hash value first arises. Further, when mismatch of hash values occurs, the reproduction test module 143 transmits one of the test packets T2 and T3 in which mismatch of hash values occurs to the packet division circuit 154 again once or more times, being able to determine whether same results may be obtained (whether a failure is reproduced) regarding the hash values.

By the above-described processing, the reproduction test module 143 is permitted to determine whether or not an error determination region of at least one of the test packet T2 (second test data block) and the test packet T3 (third test data block) which are respectively assembled in the packet assembling circuit 155 (assembling circuit) has an inverted bit value.

### [Function Effect of Reproduction Test Using Test Packets T2 and T3]

According to the above-described reproduction test using the test packets T2 and T3, it is possible to detect a memory stack failure which is not detected in the test packet T1 and to confirm reproducibility of the memory stack failure by another transmission of the test packet T2 or T3.

Further, the reproduction test using the test packets T2 and T3 is also performed merely by transmitting (inputting) the test packets T2 and T3 to the packet division circuit 154 as is the case with the reproduction test using the test packet T1. Accordingly, it is possible to perform a reproduction test in an operation state (service state) of the communication device 10.

### [Failure Confirmation Test Using Shared Memory Address Information (Shared Memory Diagnosis)]

As described above, cells of a plurality of cell flows are stored in a shared memory (memory 162) in the QoS processing circuit 16. Therefore, a writing position of a cell of a certain cell flow with respect to the memory 162 changes depending on a storage state of cells of other cell flows. Accordingly, it is not guaranteed that a writing position of a test cell with respect to the memory 162 is same as a writing position of an original cell in the above-described reproduction test. Therefore, even in a case where a bit error caused by the memory 162 of the QoS processing circuit 16 is suspected, it has been hard to perform a reproduction test in the same conditions as those of the original cell.

Therefore, when a failure between the QoS processing circuit 16 and switch 1 is suspected from a mismatch state of a plurality of hash values in a cell in an occurrence of the error packet E1, the reproduction test module 143 executes a failure confirmation test using shared memory address information which is included in tailer information, as following.

The failure confirmation test may be executed in parallel with or independently from the reproduction test using the test packet T1 or the reproduction test using the test packets T2 and T3. In a case where the communication device 10 is in an operation (in service), the failure confirmation test is executed when an address specified on the basis of the shared memory address information is in a vacancy state. For example, the control circuit 17 monitors a vacancy state of the memory 162 and notifies the device control circuit 14 (the CPU 141A) of the vacancy state. The CPU 141A (the reproduction test module 143) executes the failure confirmation test when detecting the vacancy state of a test object address.

The failure confirmation test is performed as following. Namely, the reproduction test module 143 executes a writing/reading (W/R) test of a memory region on the basis of shared memory address information included in tailer information, that is, an address pointer of the memory 162, as depicted in FIG. 12.

Specifically, the CPU 141A (the reproduction test module 143) of the device control circuit 14 transmits an instruction of a W/R test of the corresponding memory region with respect to the control circuit 17 (the CPU 171A) of the corresponding forwarding processing circuit 12 and the CPU 171A accesses the memory 162 in accordance with the instruction so as to execute the W/R test. Writing data and reading data of the W/R test are transmitted to the reproduction test module 143. Here, the CPU 171A may further transmit a determination result of match/mismatch between the writing data and the reading data. Alternatively, only a determination result of match/mismatch may be transmitted to the reproduction test module 143.

When the writing data and the reading data do not agree with each other, the reproduction test module 143 determines that a failure is present in a shared memory region of a test object. Thus, according to the failure confirmation test, it is possible to determine whether or not a suspected part has a failure by the W/R test (that is, diagnosis of a shared memory) of a corresponding region when a failure of the shared memory region is suspected.

### [Processing Example of Reproduction Test Module]

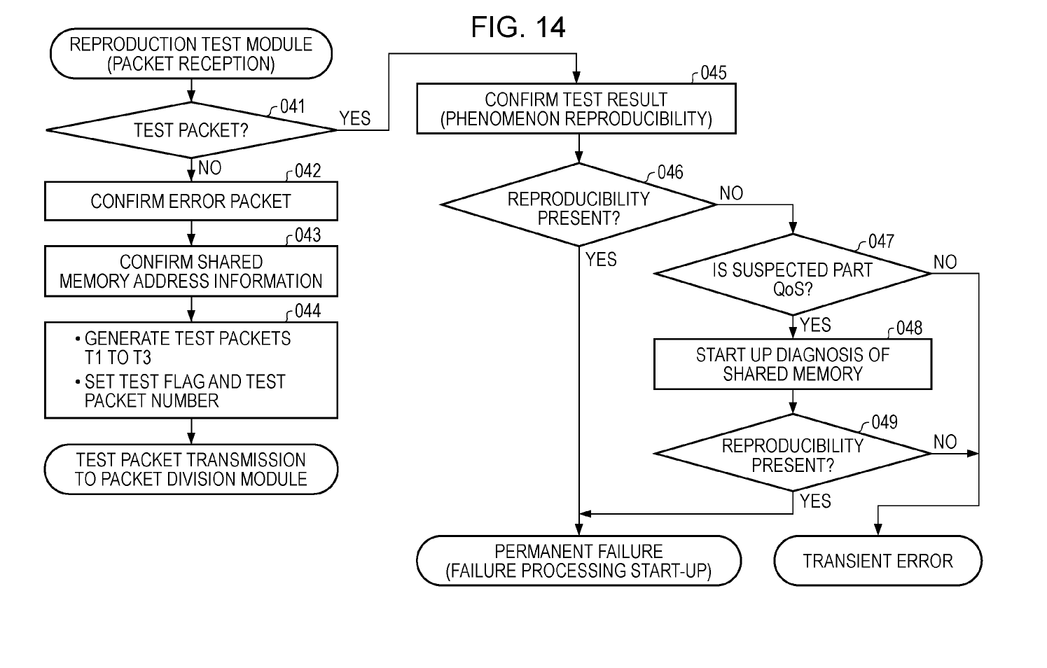

FIG. 14 is a flowchart illustrating a processing example of the device control circuit 14 according to the above-described reproduction test and failure confirmation test. Processing of the device control circuit 14 illustrated in FIG. 14 is executed by the reproduction test module 143 which is a function by a program execution of the CPU 141A.

Referring to FIG. 14, the reproduction test module 143 (the CPU 141A) starts the processing in response to packet reception. The reproduction test module 143 first determines whether or not the received packet is a test packet (operation 041). That is, the reproduction test module 143 determines whether the received packet is a normal packet (error packet E1) or a test packet on the basis of whether or not the packet has a test flag (a test flag is on). When the received packet is the error packet E1, the processing goes to operation 042.

In operation 042, the reproduction test module 143 executes confirmation processing of the error packet. Namely, the reproduction test module 143 refers to a plurality of hash values in a cell included in tailer information which is received with the error packet E1, so as to confirm mismatch of the hash values, that is, an occurrence of an error. Subsequently, the reproduction test module 143 confirms shared memory address information included in the tailer information (operation 043). Here, the reproduction test module 143 may request the control circuit 17 to forward the tailer information in the processing of above-mentioned operation 042.

Then, the reproduction test module 143 generates test packets T1 to T3 (operation 044). Namely, the reproduction test module 143 generates the test packet T1 (a copy of the error packet E1), the test packet T2 (all zero packet), and the test packet T3 (all one packet) on the memory 142B and sets test flags to the test packets T1 to T3 respectively. Further, the reproduction test module 143 sets test packet numbers to the test packets T1 to T3 respectively and stores the respective test packet numbers in the memory 1428. For example, test packet numbers “1”, “2”, and “3” are imparted to the test packets T1, T2, and T3 respectively.

Then, the reproduction test module 143 transmits the test packets T1 to T3 to the packet division circuit 154.

Subsequently, the reproduction test module 143 receives the test packets T1 to T3 which are assembled at the packet assembling circuit 155 and corresponding tailer information and stores the test packets T1 to T3 and the tailer information in the memory 1428. The processing of operation 041 is performed in the reception of the test packets T1 to T3. At this time, the test flags are set for the test packets T1 to T3, so that the processing goes to operation 045.

In operation 045, the reproduction test module 143 executes confirmation processing of a test result (phenomenon reproducibility). Namely, whether a mismatch state of a plurality of hash values in tailer information agrees with a mismatch state of an original is determined. Further, the reproduction test module 143 determines presence/absence of a bit error (bit inversion caused by a memory stack failure) based on the tailer information (hash values) of the test packets T2 and T3. Thus, the reproduction test module 143 confirms presence/absence of reproducibility of a failure based on the test packets T1 to T3.

Here, such configuration is also applicable that the packet assembling circuit 155 which acquires tailer information or the control circuit 17 of the forwarding processing circuit 12 in which the packet assembling circuit 155 is included performs determination processing similar to the processing of above-described operation 045 so as to transmit a confirmation result of reproducibility to the reproduction test module 143, instead of the above-described operation 045, and the reproduction test module 143 performs only confirmation of a content of the transmitted confirmation result of reproducibility in operation 045.

Then, the reproduction test module 143 determines whether or not the phenomenon has reproducibility (operation 046). When the reproduction test module 143 determines that the phenomenon has reproducibility (YES in operation 046), the reproduction test module 143 determines that the phenomenon is a permanent failure and starts up failure processing.

On the other hand, when the reproduction test module 143 determines that the phenomenon has no reproducibility (NO in operation 046), the reproduction test module 143 determines whether or not a suspected part of the permanent failure is the QoS processing circuit 16 (operation 047). The determination may be performed by determining whether or not mismatch of a plurality of hash values is originated from the hash value “H2” which is stored in a cell in the QoS processing circuit 16.

When the suspected part of the permanent failure is not the QoS processing circuit 16 (NO in operation 047), it is determined that a bit error occurring with respect to an original IP packet is a transient failure. On the other hand, when the suspected part of the permanent failure is the QoS processing circuit 16 (YES in operation 047), the reproduction test module 143 executes shared memory diagnosis using the above-described shared memory address information (operation 048).

Then, the reproduction test module 143 determines whether or not the phenomenon has reproducibility (operation 049). In operation 049, when the reproduction test module 143 recognizes match between the writing data and the reading data as a result of the W/R test in the shared memory diagnosis, the reproduction test module 143 determines that reproducibility is not present (NO in operation 049). Then, it is determined that a bit error of the original IP packet occurs due to a transient failure. On the other hand, when the reproduction test module 143 recognizes mismatch between the writing data and the reading data, the reproduction test module 143 determines that reproducibility is present (YES in operation 049). In this case, it is determined that a permanent failure occurs, and the failure processing is started up.

### <Failure Processing>

The following processing is performed as failure processing. For example, the reproduction test module 143 (the device control circuit 14) displays failure notification information using at least tailer information on a display device (not depicted) which is included in the monitoring terminal (console) 20 (FIG. 2) connected to the device control circuit 14.

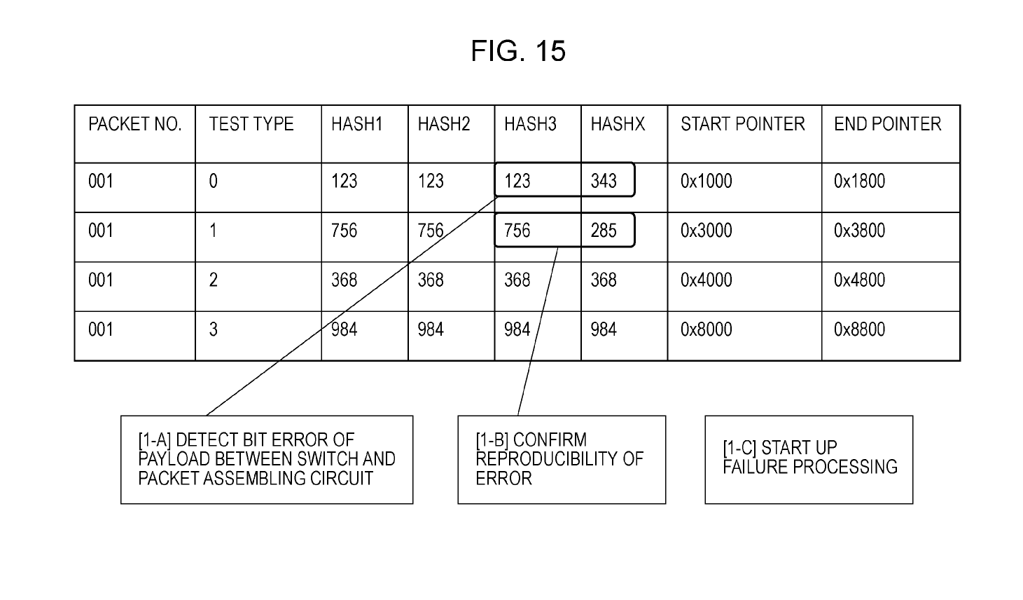

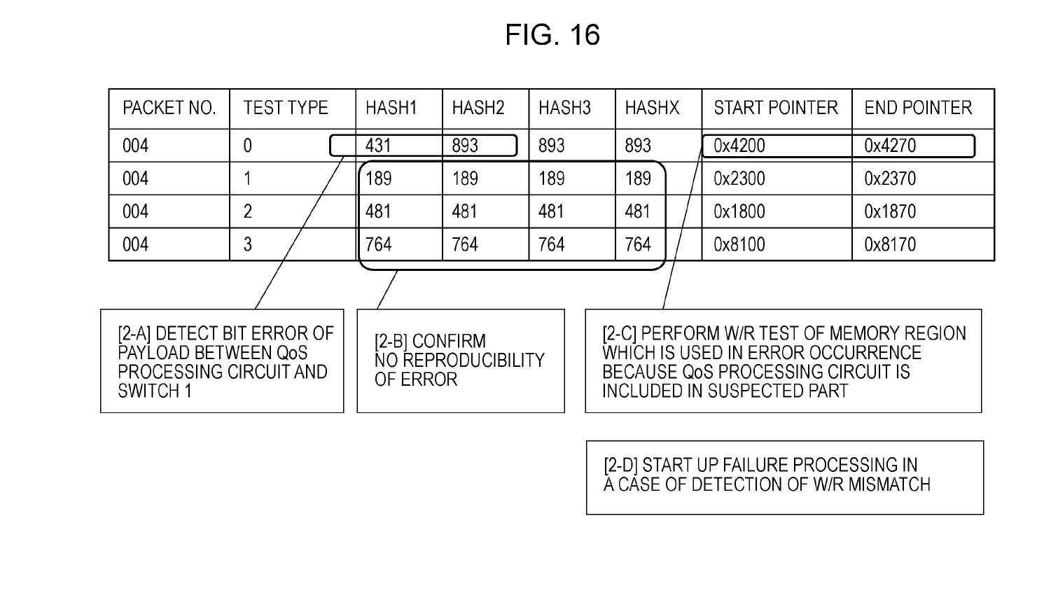

FIGS. 15 and 16 illustrate display examples of failure notification information. FIG. 15 illustrates failure notification information of a case where mismatch (inconsistency) of hash values has reproducibility, by a table. Here, in the table of FIG. 15, “Hash1” denotes a hash value which is stored in the QoS processing circuit 16 and “Hash2” denotes a hash value which is stored in switch 1. Further, “Hash3” denotes a hash value which is stored in switch 3 and “HashX” denotes a hash value which is stored in the packet assembling circuit 155. That is, display of hash values of the packet division circuit 154 and switch 2 are omitted. Here, hash values of the packet division circuit 154 and switch 2 are same as “Hash1” in FIG. 15.

In the table, packet No. represents identification information of a packet and is set in operation 044 illustrated in FIG. 14. Test type represents a type of a test packet which is used in a reproduction test. In the example of FIG. 15, “0” denotes an original IP packet, “1” denotes a test packet T1, “2” denotes a test packet T2, and “3” denotes a test packet T3. Start pointer and end pointer represent shared memory address information (namely, an address pointer) included in tailer information of each packet.

Here, tailer information is obtained for every cell, so that the table depicted in FIG. 15 may be displayed for every cell. For example, only tailer information of one cell which is used in determination of failure processing start-up may be displayed.

In the example illustrated in the table of FIG. 15, it is detected that a bit error of a payload has occurred between switch 3 and the packet assembling circuit 155, on the basis of a value of “Hash3” and a value of “HashX” in a record of the test type “0” (original IP packet) [1-A].

Further, it is confirmed that an occurrence state of hash value fluctuation agrees with that of the original, that is, reproducibility of an error is present, on the basis of a value of “Hash3” and a value of “HashX” in a record of the test type “1” (test packet T1) [1-B]. Due to such reproducibility confirmation, failure processing is started up [1-C].

FIG. 16 illustrates another display example of failure notification information. FIG. 16 illustrates failure notification information of a case where inconsistency of hash values has no reproducibility and a shared memory is included in a suspected part of a permanent failure, by a table. In the table of FIG. 16 as well, display of hash values of the packet division circuit 154 and switch 2 is omitted as is the case with the table of FIG. 15. Here, in FIG. 16, a hash value of the packet division circuit 154 is same as “Hash1”. A hash value of switch 2 is same as “Hash3”.

In the example illustrated in the table of FIG. 16, it is detected that a bit error of a payload has occurred between the QoS processing circuit 16 and switch 1, on the basis of a value of “Hash1” and a value of “Hash2” in a record of the test type “0” (original IP packet) [2-A].

However, reproducibility of an error is not confirmed from hash values in records corresponding to the following test type “1” (test packet T1), test type “2” (test packet T2), and test type “3” (test packet T3) [2-B].

Therefore, shared memory diagnosis (W/R test) using a start pointer and an end pointer (shared memory address information) of the record of the test type “0” is performed [2-C]. Then, when mismatch between writing data and reading data is detected, failure processing is started up [2-D].

As the failure processing, the device control circuit 14 specifies a permanent failure part on the basis of a plurality of hash values. That is, in the ROM/memory 142 of the device control circuit 14, information of each circuit which stores a hash value on the above-described cell transmission path is preliminarily stored as device information of the communication device 10. The CPU 141A of the device control circuit 14 recognizes a pair of circuits, in which fluctuation of a hash value occurs, by associating a hash value with a circuit, so as to specify a circuit which is an origin of the hash value fluctuation as a circuit which is a permanent failure part. For example, when a hash value stored by switch 1 and a hash value stored by switch 2 have values different from each other, the CPU 141A determines that a failure has occurred between switch 1 and switch 2 by associating device information with the hash values and specifies switch 2 as a permanent failure part.

Then, recovery processing of which a failure processing object is the circuit (device) specified as the permanent failure part is executed. The recovery processing is a reload processing, for example. As the reload processing, rewriting of a device driver of the circuit (device) is executed, for example. When the circuit (device) which is specified as the permanent failure part has the redundant configuration, the recovery processing is performed after switching processing to an auxiliary system (auxiliary circuit (auxiliary device)). When the circuit does not have the redundant configuration, the communication device 10 is temporarily stopped and the recovery processing is performed. Such failure processing is autonomously performed in the communication device 10. However, the failure processing may be manually performed. Thus, local failure processing (reload processing) with respect to a specified permanent failure part is performed, being able to shorten time for recovery and reduce operations. Further, a record of the test type 0 illustrated in FIG. 15 and FIG. 16 may be displayed on the terminal 20 before the reproduction test.

### <Function Effect of Embodiment>

According to the above-describe embodiment, it is possible to facilitate specification of a failure occurrence part on a cell transmission path through which a plurality of cells obtained by decomposing an IP packet are forwarded. Further, it is possible to perform a reproduction test and determine whether a failure is a transient failure or a permanent failure in an operation state of the communication device 10. Accordingly, it is possible to specify a failure suspected part in which abnormality is intermittently detected and rapidly and device-autonomously start up failure processing. Further, specifying a failure suspected part enables minimization of a range of recovery processing.

Here, the configuration example of the L3SW has been described in the embodiment. However, when a L2SW is applied as the communication device 10, a MAC frame is an object of cell division instead of an IP packet. An IP packet and a MAC frame are examples of a “data block”.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A communication device comprising:
a division circuit configured to divide a data block received from a network into a plurality of cells;
a plurality of processing circuits, each configured to execute predetermined processing with respect to the plurality of cells received from the division circuit;
an assembling circuit configured to assemble the data block from the plurality of cells received from the plurality of processing circuits; and
a first control circuit configured to determine whether or not mismatch is present in a plurality of calculation results stored in the cell,
wherein at least two of the division circuit, the plurality of processing circuits, and the assembling circuit store the calculation result of error check calculation with respect to at least one of the plurality of cells, in the cell.

2. The communication device according to claim 1, further comprising:
a second control circuit configured to supply a first test data block that is a copy of the data block assembled from the plurality of cells to the division circuit when mismatch is present in the plurality of calculation results stored in the cell, and determine whether or not a mismatch state of a plurality of calculation results of the error check calculation, the plurality of calculation results being stored in at least one of a plurality of test cells, the test cells being generated by dividing a test packet in the division circuit and reaching the assembling circuit through the plurality of processing circuits, agrees with a mismatch state of the plurality of calculation results related to the data block.

3. The communication device according to claim 2, wherein the second control circuit supplies a second test data block of which all bit values in at least an error determination region are 0 and a third test data block of which all bit values in at least an error determination region are 1 to the division circuit in addition to the test packet, and determines whether or not at least one of the error determination regions of the second test data block and the third test data block, the second test data block and the third test data block being respectively reaching the assembling circuit through the plurality of processing circuits, has an inverted bit value.

4. The communication device according to claim 2, wherein:
at least one of the plurality of processing circuits stores the plurality of cells in a memory for processing with respect to the plurality of cells and stores memory address information indicating an address of the memory, in at least one of the plurality of cells in which the calculation results are stored, and
the second control circuit executes diagnosis processing of the memory by using the memory address information when mismatch is present in the plurality of calculation results related to the data block.

5. The communication device according to claim 3, wherein:
at least one of the plurality of processing circuits stores the plurality of cells in a memory for processing with respect to the plurality of cells and stores memory address information indicating an address of the memory, in at least one of the plurality of cells in which the calculation results are stored, and
the second control circuit executes diagnosis processing of the memory by using the memory address information when mismatch is present in the plurality of calculation results related to the data block.

6. A failure detection method of a communication device, comprising:
dividing a data block received from a network into a plurality of cells, by a division circuit;
executing predetermined processing with respect to the plurality of cells received from the division circuit, by each of a plurality of processing circuits;
assembling the data block from the plurality of cells received from the plurality of processing circuits, by as assembling circuit;
storing a calculation result of error check calculation with respect to at least one of the plurality of cells, in the cell by at least two of the division circuit, the plurality of processing circuits, and the assembling circuit; and
determining whether or not mismatch is present in a plurality of calculation results stored in the cell, by a control circuit included in the assembling circuit or independent from the assembling circuit.
